(19) United States
(12) Patent Application Publication
(10) Pub. No.: US 2004/0133762 A1
(43) Pub. Date: Jul. 8, 2004

(54) LINEAR ACCESS WINDOW

(76) Inventors: Rui-Fu Chao, Hsin-Chu City (TW); Tai-Chung Chang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,285

(22) Filed: Jan. 6, 2003

(51) Int. Cl. G06F 12/00

(52) U.S. Cl. 711/220

(57) ABSTRACT

Calling a linear access window at a predetermined fixed address allows accessing of a data block in an on-chip memory of a microprocessor. Hardware concatenation of a page number held in a start address register with an indicated offset produces the needed complete address without the need of an adder. In the process, the hardware checks that the indicated address falls within a predetermined address space. If the address exceeds the predetermined address space, during concatenation the hardware substitutes the lowest page number in the predetermined address space for the current page number in the start address register, effectively wrapping the address space without the need for software checking and intervention.

### BACKGROUND OF INVENTION

1. Field of the Invention

The present invention relates to mapping to an internal, on-chip memory block of a microprocessor. More specifically, a linear access window mapping to the on-chip memory block of the microprocessor is disclosed.

2. Description of the Prior Art

Microprocessors, such as Intel's 8051 developed in 1980, remain extremely popular controllers today with many independent manufacturers producing vast quantities of 8051 derivatives annually. A typical microprocessor includes a CPU, five or six interrupts, two or three counters or timers, several I/O ports, and differing arrangements of memory.

Please refer to FIG. 1 that illustrates one example of a possible memory arrangement of a microprocessor used for controlling the transmission of Ethernet packets. While controlling Ethernet packet transmission is certainly not the only possible use for a microprocessor, this use is illustrated here and throughout this paper to aid in the understanding of the invention. However, this use serves only as an example and it is understood that the present invention is not limited to microprocessors serving as Ethernet packet processors.

The addresses for the memory in FIG. 1 are given in hexadecimal notation indicated by a leading “0x”, for example, the address 0x3FFF is equal to the address 16383 in decimal notation. The memory shown in FIG. 1 is a continuous address space of 64 K of RAM and comprises a Data Memory, a Reserved space, Registers, and 32 K of External Memory. A starting address register DPTR holds the starting address of an Ethernet packet temporarily stored in the Data Memory. In this example, the Data Memory comprises the addresses from 0x0000 through 0x3FFF and is internal, on-chip memory for higher speed processing.

An Ethernet packet includes a header with numerous predefined fields at predetermined locations in the header. For example, bytes 1-6 of the header indicate the Ethernet destination address, bytes 7-12 indicate the Ethernet source address, bytes 13-14 indicate the type/length of the packet, and bytes 25-26 indicate a checksum for the IP header.

During the processing of the Ethernet packet, the microprocessor may require access to one or more of the predefined fields in the header. Because only the starting address of the Ethernet packet is held in the DPTR, each access to a field in the header requires computing a local memory address for that field. For example, to access the IP destination address located in bytes 31-34, the microprocessor needs to add a 31-byte offset to the DPTR to obtain the memory address of the IP destination address. This often repeated and required addition slows the processing of the Ethernet packet. Even accessing the same header field in sequentially processed Ethernet packets requires the same steps because new Ethernet packets are frequently loaded into different locations in the Data Memory.

Moreover, because most microprocessors are 8 bit machines and an address space of 64 K requires a 16 bit address, addresses need to be processed in two parts; the most significant 8 bits of the address represent a page number and are indicated first, followed by the remaining 8 least significant bits of the address indicating the offset within that page. This two-step process repetitively delays processing of the Ethernet packets.

In addition, the Ethernet packets are variable in length and may be placed anywhere within the Ethernet packet buffer. It is possible for a packet to begin at a high address, say 0x3F00, and wrap around to a low address, say 0x0000 for the portion of the packet that will not fit under the 0x3FFF upper limit of the Data Memory. Because of this, the software accessing the Ethernet packet header needs to check each address, provided by the sum of the DPTR and the offset, to see if the address exceeds the upper limit of the Data Memory and to alter it accordingly. This need to check the range of each address increases code size and delays processing of the Ethernet packets.

### SUMMARY OF INVENTION

It is therefore a primary objective of the claimed invention to eliminate the need of a two-step address-indicating process when accessing data stored in the internal, on-chip memory of a microprocessor.

It is another primary objective of the claimed invention to reduce code size and resultantly increase execution speed of code accessing data stored in the internal memory of a microprocessor by eliminating the need for software to validate that an indicated address is within a predetermined address range defined by the microprocessor for data storage.

Briefly summarized, the claimed invention discloses a microprocessor that includes a CPU, a start address register, an internal, on-chip memory, and a linear access window. The start address register holds the starting address of a block of data in the internal memory.

In a preferred implementation of the claimed invention, the data blocks begin on page boundaries in the on-chip memory allowing the start address register to be only 8 bits, defining the address of the page where the data block begins. Accessing the data block is done by calling a linear access window at a predetermined fixed address, such as 0x60yy, where “0x” indicates hexadecimal notion, “60” indicates that the page number held in the start address register is to be used as the page number portion of the complete address, and “yy” indicates a desired offset in bytes on that page. Hardware effectively concatenates the page number held in the start address register with the indicated offset producing the needed complete address without the need of an adder. In the process, the hardware checks that the indicated address falls within a predetermined address space. If the address exceeds the predetermined address space, the hardware substitutes the lowest page number in the predetermined address space for the current page number in the start address register, effectively wrapping the address space without the need for software checking and intervention.

In a similar implementation of the claimed invention, there is no requirement for the data blocks to begin on page boundaries in the on-chip memory. A 16-bit start address register and an adder are used to provide the completed address but the benefits of hardware wrapping of the address space are retained.

Another implementation of the claimed invention includes at least a second linear access window and a second start address register allowing similar access to additional data blocks while providing the same benefits.

It is an advantage of the claimed invention that a linear access window can dynamically map and re-map to any location within the on-chip memory of a microprocessor without requiring a change in the calling software.

It is another advantage of the claimed invention that using a linear access window can eliminate the use of an adder when accessing a data block in the on-chip memory of a microprocessor.

It is another advantage of the claimed invention that the linear access window can reduce software code size and thereby increase data access speed by using hardware to verify that the address falls within a predetermined address range and provides automatic address wrapping when the predetermined address range is exceeded.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional diagram of a memory arrangement of a microprocessor according to the prior art.

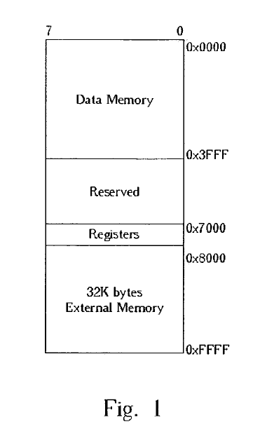

FIG. 2 is a functional diagram of a memory arrangement of a microprocessor according to the present invention.

FIG. 3 illustrates how a linear access window maps to an on-chip memory according to the present invention.

FIG. 4 illustrates how a linear access window maps to overlapping memory blocks according to the present invention.

FIG. 5 illustrates how a linear access window maps to memory blocks wrapped from high memory to low memory according to the present invention.

### DETAILED DESCRIPTION

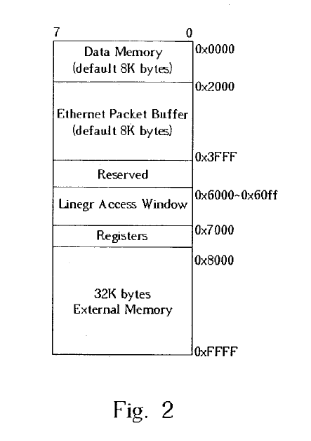

Please refer to FIG. 2 of a memory arrangement of a microprocessor according to the present invention. The addresses for the shown memory space are in hexadecimal notion. For example, the on-chip memory of the memory space of the present invention extends from 0x0000 to 0x3FFF (from 0 to 16383 (16K) if translated into decimal notion).

The memory space shown in FIG. 2 comprises an internal, on-chip memory comprising a data memory and an Ethernet packet buffer, a reserved space, at least one linear access window, a plurality of registers, and an external memory. Although FIG. 2 shows the on-chip memory divided into a data memory and an Ethernet packet buffer, there is no need for this to be so. The on-chip memory may comprise a single data memory or more than two divisions. FIG. 2 is merely an example.

It is also to be understood that the use of a microprocessor to process Ethernet packets as shown in FIG. 2 and described in this paper is merely used as an example to teach the present invention. The exact use of the on-chip memory may vary from processor to processor and the present invention is not to be limited to only microprocessors controlling Ethernet packets or to the exact arrangement of the on-chip memory shown in FIG. 2.

One of the registers is defined as a start address register and comprises a starting address of an Ethernet packet (or data block) in the on-chip memory. Because the on-chip memory allows quicker data access than the external memory, it is obviously beneficial to load active data, for example, the Ethernet packet being processed, into the on-chip memory. Also, the ability to locate the Ethernet packet at varying locations within the on-chip memory holds additional benefits obvious to one skilled in the art. However, locating the Ethernet packet at varying locations in the on-chip memory necessitates the start address register and complicates accessing of specific fields in the header of the Ethernet packet.

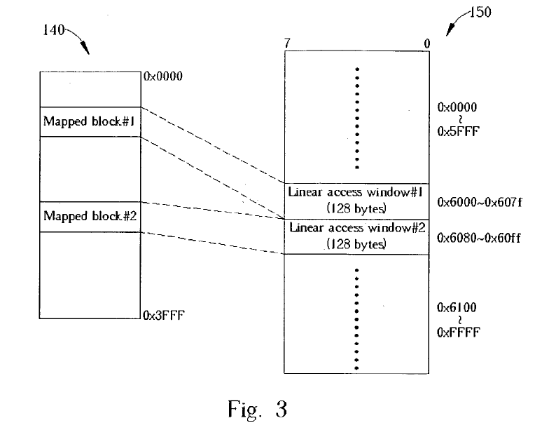

To solve this problem and simplify accessing of specific fields within the Ethernet packet, the present invention uses one or more linear access windows. Although each linear access window is part of the total address space of the microprocessor, the linear access windows are not actually a part of physical memory. Instead, the linear access window comprises a predetermined address range. FIG. 3 illustrates a 128 byte range of 0x6000 through 0x607F for a first linear access window and another 128 byte address range of 0x6080 through 0x60FF for a second linear access window. Although the number of linear access windows possible is limited only by available memory space, two linear access windows are shown in the FIGS.3, 4, and 5 to illustrate possible uses of multiple linear access windows.

A present invention embodiment comprising a single linear access window will be described here to simplify discussion. This preferred embodiment of the present invention utilizes an 8-bit start address register that holds a page number portion of a starting address of an Ethernet packet stored in the on-chip memory. The register does not necessarily have to hold only the page number or be exactly eight bits in size, but in a microprocessor having a 16-bit address space, it is convenient to divide an address into two pieces with the most significant 8-bit portion of the address representing the page address and the least significant 8-bit portion of the address representing an offset within the page.

When Ethernet packet has been loaded into the on-chip memory and the starting page number (for example 0x3F) has been loaded into the start address register, the Ethernet packet can be accessed through the linear access window, rather than directly as in the prior art. During processing of the Ethernet packet, the software may require access to a particular field within the header of the Ethernet packet, say the IP destination address located in bytes 31-34. According to the present invention, regardless of the actual physical location in the on-chip memory, this field is accessed at the address 0x601F (the base address of the linear access window, 0x6000, plus 31 byte offset).

Because the address 0x601F falls within the predetermined address range (0x6000 through 0x607F) of the linear access window, the hardware traps the address and performs two functions. The first function is to replace the eight-most-significant-bit page number portion of the currently specified address (0x601F) with the 8-bit page number held in the start address register (0x3F). So, the originally called address, 0x601F becomes 0x3F1F in this example.

The second function carried out by the hardware is to check to insure that this new address 0x3F1F falls within the on-chip memory address space. If the new address 0x3F1F1F falls within the on-chip memory address space, the new address 0x3F1F is used as the address to access the IP destination address field in the header of the Ethernet packet. If the new address 0x3F1F falls outside the on-chip memory address space, the page number portion of the new address 0x3F1F is first replaced by the page number of the lowest page in the portion of the on-chip memory designated as the Ethernet buffer before providing access. In another example, the new address may therefore may become 0x001F, effectively wrapping the address without the need of software checking, reducing code size and speeding data access. Obviously, the lowest page number could be 0x00 or it could be any predetermined page within the on-chip memory. Additionally, another embodiment of the present invention utilizes an Ethernet buffer that does not extend to the end of the on-chip memory space. The point is that a minimum page and a maximum page are defined in the hardware. The hardware comprised by and serving the linear access window not only swiftly provides the desired access address without the use of an adder, but additionally reduces software code size and complexity by insuring that the access address provided by the linear access window is within the Ethernet buffer and correct.

Another embodiment of the present invention functions somewhat similarly to the preferred embodiment with one major difference. While the preferred embodiment requires Ethernet packets to be loaded into the Ethernet buffer so that the loaded Ethernet packet begins on a page boundary because the start address register is only required to hold the 8-bit page address, there is no such requirement in this embodiment. The start address register is merely extended to hold the full 16-bit start address and the supplied page offset is added to the value in the start address register before checking to insure that the new address is within the address range defined for the Ethernet buffer. The benefits of reduced code size and complexity are retained.

Please refer now to FIGS. 3, 4, and 5. FIG. 3 shows the full address space 150 of a microprocessor including a first linear access window located at 0x6000 through 0x607F and a second linear access window located at 0x6080 through 0x60FF. A defined address range 140 is shown separate from the address space 150 in FIGS. 3, 4 and 5 for convenience, however the defined address range 140 is a physical part of the address space 150.

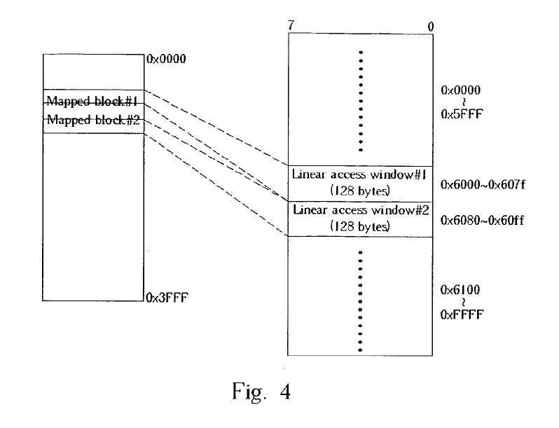

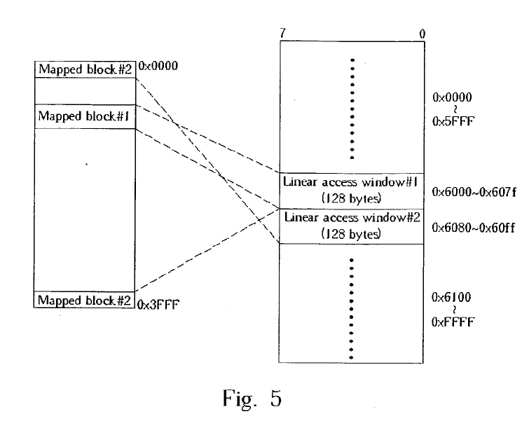

Each linear access window maps to one distinct block within the defined address range 140 of the on-chip memory. Using multiple linear access windows can facilitate multiple data packet accessing or even copying the data packet from one location to another within the defined address range 140. As is shown in FIG. 3, the mapped blocks may be independently arranged. As shown in FIG. 4, the mapped blocks may be overlapping. And as in FIG. 5, one or more of the mapped blocks may wrap around from high memory addresses to low memory addresses within the defined address range.

In contrast to the prior art, it is an advantage of the claimed invention that a linear access window can dynamically map and re-map to any location within the on-chip memory of a microprocessor without requiring a change in the calling software. All calling routines can be written to access data via the linear access window and not worry about where the data is located in memory.

It is another advantage of the claimed invention that using a linear access window can eliminate the use of an adder when accessing a data block in the on-chip memory of a microprocessor.

It is another advantage of the claimed invention that the linear access window can reduce software code size and thereby increase data access speed by using hardware to verify that the address falls within a predetermined address range and provides automatic address wrapping when the predetermined address range is exceeded.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An embedded microprocessor comprising:
a central processing unit for executing instructions;
an on-chip memory block having an address space for data storage;
a start address register for holding a starting address of a first data block in the on-chip memory block; and
a first linear access window having a first predetermined address range for providing access to the first data block in the on-chip memory block;
wherein when the central processing unit executes an instruction to access an address within the first predetermined address range of the first linear access window, the first data block in the on-chip memory block is accessed according to the starting address held in the start address register and an offset provided by the instruction.

2. The embedded microprocessor of claim 1 wherein when an address according to the starting address held in the start address register and the offset provided by the instruction exceeds the on-chip memory block address space for data storage, the first data block in the on-chip memory block is accessed according to the lowest address in the address space for data storage in the on-chip memory block and the offset provided by the instruction.

3. The embedded microprocessor of claim 1 wherein the starting address held in the start address register indicates a page number in the on-chip memory block and the offset provided by the instruction indicates the offset within that page.

4. The embedded microprocessor of claim 3 wherein the page number in the on-chip memory block comprises eight bits and the offset within that page comprises eight bits.

5. The embedded microprocessor of claim 4 wherein the offset within that page is indicated by the eight least significant bits of the address within the first linear access window indicated by the instruction.

6. The embedded microprocessor of claim 5 further comprising a second start address register and a second linear access window at a second predetermined address range for accessing a second data block in the on-chip memory block.

7. The embedded microprocessor of claim 6 wherein the first data block and the second data block overlap.

8. The embedded microprocessor of claim 1 wherein the predetermined address range of the first linear access window extends 128 bytes.

9. The embedded microprocessor of claim 8 wherein the predetermined address range of the first linear access window is located from hexadecimal 0x6000 to hexadecimal 0x607F.

10. An embedded microprocessor comprising:
an on-chip memory block having an address space for data storage;
a start address register for holding a starting address of a first data block in the on-chip memory block; and
a first linear access window having a first predetermined address range, an address within the first predetermined address range accesses the first data block in the on-chip memory block according to the starting address and the address within the first predetermined address range.

11. The embedded microprocessor of claim 10 wherein when an address according to the starting address and the address within the first predetermined address range exceeds the on-chip memory block address space for data storage, the first data block in the on-chip memory block is accessed according to the lowest address in the address space for data storage in the on-chip memory block and the address within the first predetermined address range.

12. The embedded microprocessor of claim 10 wherein the starting address indicates a page number in the on-chip memory block and the address within the first predetermined address range indicates an offset within that page.

13. The embedded microprocessor of claim 12 wherein the page number in the on-chip memory block comprises eight bits and the offset within that page comprises eight bits.

14. The embedded microprocessor of claim 13 wherein the offset within that page is indicated by the eight least significant bits of the address within the first linear access window.

15. The embedded microprocessor of claim 14 further comprising a second start address register and a second linear access window at a second predetermined address range for accessing a second data block in the on-chip memory block.

16. The embedded microprocessor of claim 10 wherein the first predetermined address range of the first linear access window is located from hexadecimal 0x6000 to hexadecimal 0x607F.

17. A method for accessing a data in an on-chip memory block of a microprocessor, the microprocessor comprising a linear access window and a start address register for holding a starting address of the data, the linear access window comprising an address space outside of the on-chip memory block, the method comprises:
accessing the data in the on-chip memory block according to the starting address and the address within the address space of the linear access window.

18. The method of claim 17 wherein the starting address indicates an 8-bit page number in the on-chip memory block and the eight least significant bits of the address within the address space of the linear access window indicates an offset within that page.
